(19) United States
(12) Patent Application Publication
(10) Pub. No.: US 2008/0082516 A1
(43) Pub. Date: Apr. 3, 2008

(54) System for and method of searching distributed data base, and information management device

(76) Inventor: Hiroshi Niina, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/896,042

(22) Filed: Aug. 29, 2007

(30) Foreign Application Priority Data
Sep. 28, 2006 (JP) 2006-265096

(51) Int. Cl. G06F 17/30; G06F 7/10

(52) U.S. Cl. 707/4; 707/5; 707/E17.014; 707/E17.017

(57) ABSTRACT

A search system includes a plurality of information management devices that manage a plurality of databases (DBs), and a search device. The search device includes a plan generation unit that generates a search plan from a search request, a determination unit determines the information management devices each of which executes the search instruction contained in the search plan and generates execution information used to execute the search instruction, and a request transmission unit that transmits the execution information generated by the determination unit to any one of the information management device. The information management device includes an execution unit that executes a process using execution information, a correlation unit that correlates acquisition source information to identify DB as an acquisition source with an execution result, and a transfer unit that transfers the execution result to the information management device that executes the process to use the execution result.

### CROSS-REFERENCE TO RELATED APPLICATIONS

This application is based upon and claims the benefit of priority from the prior Japanese Patent Application No. 2006-265096, filed on Sep. 28, 2006; the entire contents of which are incorporated herein by reference.

### BACKGROUND OF THE INVENTION

1. Field of the Invention

The present invention relates to a technology for searching a distributed database according to a given search condition.

2. Description of the Related Art

In recent years, a horizontal-fragmentation type distributed database system is widely known. The distributed database system performs processing by fragmenting data that consists of a large number of items into a plurality of pieces as fragments so that the items in respective fragments are equalized to one another, and by registering each fragment of the fragmented data in a plurality of databases connected to a network.

The search process of the distributed database is necessary to transfer an intermediate result of the search process between devices that are distributed yet connected to each other through the network and to continuously execute steps of the search process. In the search process, the transfer process of the intermediate result through the network requires extremely high time cost as compared with that of other processes such as arithmetic operations in a central processing unit (CPU), input/output (I/O) for a memory, and I/O for a disk. Therefore, it is necessary to reduce the amount of data to be transferred as much as possible to speed up the search process.

On the other hand, the horizontally fragmented database based on the conventional technology uses an approach to avoid wasteful information transfer upon data transfer during search process, appropriately determine information required for the process, and to transfer the information. For example, in ‘Ozsu & Valduriez, “Principles of Distributed Database Systems”, Printice Hall, Chapter 13.3.3 (P. 436 to P. 444), Parallel Database Systems’ (hereinafter, “document 1”), the following technology is proposed. The technology is such that a destination of data transfer is determined using a hash function such as parallel associative join and data is transferred only to the determined destination, to thereby avoid unnecessary information transfer.

More specifically, in the method according to the document 1, a hash function specific to an attribute of data is previously assumed, and a physical database, which is a destination of an intermediate result, corresponding to a hash value as the result of the hash function is previously defined.

Consideration is given to the case where the result on a logical database is transferred to another logical database and operated therein, like “join arithmetic”. When the intermediate results of respective databases are to be transferred, a hash value for a value of the attribute of the data contained in the intermediate result is first determined. Specifically, the hash value is obtained as a result of applying the hash function to the value of the attribute. Each physical database as the destination of data transfer for each intermediate result to be transferred is determined one by one according to a previously defined correlation between the hash value and the physical database, based on the determined hash value.

In the physical database to which the data is transferred, only data which may match data therein at a comparison computation performed in the join arithmetic is distributed using the hash function, and thus the data is collected on the same physical database. In this manner, the transfer of wasteful data that may be abandoned as a result of computation can be reduced.

If it is known beforehand to perform the join arithmetic on an attribute B of data, a hash value for the attribute B of the data is previously obtained upon registration of the data, according to the correlation between the hash function and the database, which enables to determine each registration-destination physical database of individual data. Consequently, the data is registered beforehand in the registration-destination physical database determined using the above method.

Consideration is also given to the case where the join arithmetic is performed between the intermediate result on a logical database A prepared in the above manner and the intermediate result on another logical database B. In this case, specification of data to be transferred can be limited only to the result of the logical database B, of the intermediate results as the computation objects of the join arithmetic. Consequently, the data to be transferred can be reduced as compared with the method of transferring the intermediate result.

If the intermediate result is not transferred using such a system as shown in the third paragraph at page 438 of the document 1, all the results of individual logical databases need to be transferred to one physical database which belongs to another logical database. Of the data contained in the received intermediate results, data related to the data on the physical database as a transfer destination often requires only certain data. Accordingly, the transfer of data not related thereto turns out to be wasteful.

In the method according to the document 1, however, a processing load is heavy when data to be decentralized and arranged is registered. More specifically, in the method, before registration, it is necessary to predict and evaluate characteristic of data to be registered in a database, set an appropriate hash function, and previously horizontally fragment the data before search.

Therefore, for example, if the structure of data fragmentation needs to be changed during operation of the database system, the registration destination of the data has to be set again using the hash function, and this causes an increase in the processing load.

### SUMMARY OF THE INVENTION

According to one aspect of the present invention, a search system includes a plurality of information management devices that manage a plurality of databases for each database, information being distributed and stored in the databases; and a search device that is connected to the information management devices through a network and searches for the information from the information management devices, wherein the search device includes an acceptance unit that accepts a search request for the information sent from a client terminal connected to the network; a plan generation unit that analyzes the accepted search request and generates a search plan containing a search instruction to be executed by the information management devices; a determination unit that receives the search plan generated by the plan generation unit, determines the information management devices each of which executes the search instruction contained in the search plan, and generates execution information used to execute the search instruction; a request transmission unit that transmits the execution information generated by the determination unit to any one of the determined information management devices, for each search instruction contained in the generated search plan; a result reception unit that receives an execution result of the search instruction from the information management device; a result generation unit that generates a search result based on the received execution result; and a result transmission unit that transmits the generated search result to the client terminal, and the information management device includes a reception unit that receives the execution information from the search device; an execution unit that executes the search instruction by using the received execution information; a correlation unit that correlates an execution result of the executed search instruction with acquisition source information previously specified to identify each of the databases as an acquisition source of the execution result; and a transfer unit that transfers the execution result correlated with the acquisition source information to another information management device that executes the search instruction to use the execution result, wherein the execution unit further executes the search instruction to use the execution result received from the another information management device, and adds the execution result of executed search instruction to the received execution result, the correlation unit further correlates the acquisition source information to identify the database as an acquisition source of the execution result of the executed search instruction, with the received execution result added with the execution result of the executed search instruction, and the transfer unit further transfers the execution result correlated with the acquisition source information to the information management device that manages the database identified by the acquisition source information correlated to the execution result.

According to another aspect of the present invention, a search method in a search system, the search system including a plurality of information management devices and a search device, wherein the information management devices manage a plurality of databases for each database, information is distributed and stored in the databases, and the search device is connected to the information management devices through a network and searches for the information from the information management devices, wherein the search method includes accepting by the search device a search request for the information sent from a client terminal connected to the network; analyzing by the search device the accepted search request and generating a search plan containing a search instruction to be executed by the information management devices; determining by the search device the information management devices each of which executes the search instruction contained in the generated search plan and generating execution information used to execute the search instruction; transmitting by the search device the generated execution information to any one of the determined information management devices, for each search instruction contained in the generated search plan; receiving by the information management device the execution information from the search device; executing by the information management device the search instruction by using the received execution information; correlating by the information management device an execution result of the executed search instruction with acquisition source information previously specified to identify each of the databases as an acquisition source of the execution result; transferring by the information management device the execution result correlated with the acquisition source information to another information management device that executes the search instruction to use the execution result; executing by the information management device the search instruction to use the execution result received from the another information management device, and adding the execution result of the executed search instruction to the received execution result; correlating by the information management device the acquisition source information to identify the database as an acquisition source of the execution result of the executed search instruction, with the received execution result added with the execution result of the executed search instruction; transferring by the information management device the execution result correlated with the acquisition source information to the information management device that manages the database identified by the acquisition source information correlated to the execution result; receiving by the search device the execution result from the information management device; generating by the search device a search result based on the received execution result; and transmitting by the search device the generated search result to the client terminal.

According to still another aspect of the present invention, an information management device connected to an external information management device and a search device through a network, wherein the external information management device manages a plurality of databases for each database, information is distributed and stored in the databases, and the search device searches for the information, wherein the information management device includes an information storage unit that stores the database; a reception unit that receives execution information used to execute a search instruction from the search device; an execution unit that executes the search instruction by using the received execution information; a correlation unit that correlates an execution result of the executed search instruction with acquisition source information previously specified to identify each of the databases as an acquisition source of the execution result; and a transfer unit that transfers the execution result correlated with the acquisition source information to the external information management device that executes the search instruction to use the execution result, wherein the execution unit further executes the search instruction to use the execution result received from the external information management device, and adds the execution result of the executed search instruction to the received execution result, the correlation unit further correlates the acquisition source information to identify the database as an acquisition source of the execution result of the executed search instruction, with the received execution result added with the execution result of the executed search instruction, and the transfer unit further transfers the execution result correlated with the acquisition source information, to the external information management device that manages the database identified by the acquisition source information correlated to the execution result.

### BRIEF DESCRIPTION OF THE DRAWINGS

FIG. 1 is a block diagram of a search system according to one embodiment of the present invention;

FIG. 2 is a schematic diagram representing one example of a data structure of data to be registered in a database “people”;

FIG. 3 is a schematic diagram representing one example of a data structure of data to be registered in a database “auction”;

FIG. 4 is a diagram representing one example of data structures of a result storage unit and a correlation storage unit;

FIG. 5 is a diagram representing another example of the data structures of the result storage unit and the correlation storage unit;

FIG. 6 is a diagram representing another example of the data structures of the result storage unit and the correlation storage unit;

FIG. 7 is a schematic diagram representing one example of a search request;

FIG. 8 is a schematic diagram representing one example of an output format of a search result;

FIG. 9 is a block diagram of a detailed configuration of a processor;

FIG. 10 is a flowchart of a search process according to the embodiment;

FIG. 11 is a flowchart of an operator execution process for an operator;

FIG. 12 is a flowchart of an operator execution process for another operator;

FIG. 13 is a flowchart of an operator execution process for another operator;

FIG. 14 is a schematic diagram representing one example of how intermediate results are transferred;

FIG. 15 is a schematic diagram representing another example of intermediate results;

FIG. 16 is a schematic diagram representing another example of intermediate results;

FIG. 17 is a schematic diagram representing another example of intermediate results;

FIG. 18 is a schematic diagram representing another example of intermediate results; and

FIG. 19 is a block diagram representing a hardware configuration of an information management device according to the embodiment.

### DETAILED DESCRIPTION OF THE INVENTION

Exemplary embodiments of the present invention are explained in detail below with reference to the accompanying drawings.

A search system according to one embodiment of the present invention correlates information to specify a database as the acquisition source of an intermediate result with the intermediate result, and transfers only a portion, of the intermediate result, which can be an object to be processed if it is transferred, by referring to the information.

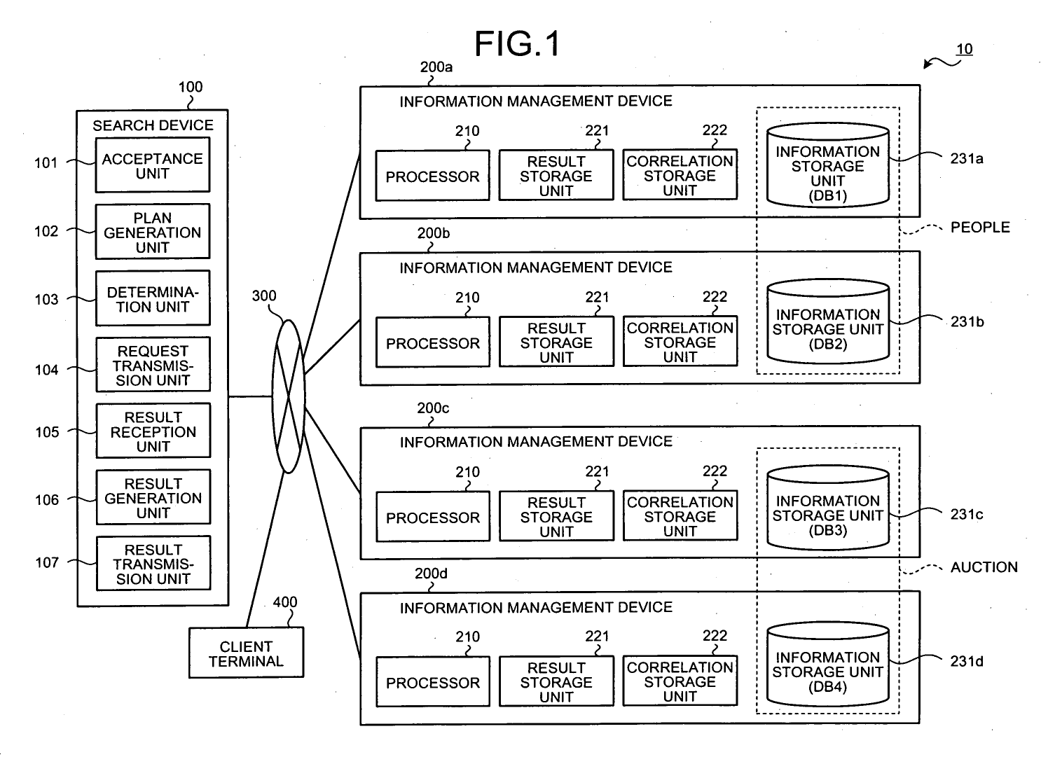

As shown in FIG. 1, a search system 10 includes a search device 100, a plurality of information management devices 200a, 200b, 200c, and 200d (hereinafter, “information management device 200” unless otherwise specified), a network 300, and a client 400.

The client 400 transmits a search request for information (data) stored in the information management device 200 to the search device 100. The client 400 is configured with an ordinary personal computer (PC) or the like.

The network 300 is connected among the search device 100, the information management device 200, and the client 400. The network 300 can be configured with any type of networks such as the Internet and a virtual private network (VPN).

A network connection between the client 400 and the search device 100 and a network connection between the information management device 200 and the search device 100 may be differently provided from each other.

The search device 100 searches for data from the information management device 200. The search device 100 includes an acceptance unit 101, a plan generation unit 102, a determination unit 103, a request transmission unit 104, a result reception unit 105, a result generation unit 106, and a result transmission unit 107.

The acceptance unit 101 accepts a search request for data from the client 400. As explained later, the acceptance unit 101 accepts a search request for a structured document having a hierarchized logical structure such as an Extensible Markup Language (XML). This type of search request allows a search result to be returned in a format of a structured document. The details of the search request are explained later.

The plan generation unit 102 analyzes the accepted search request, and generates a search plan including an operator group, a data-passing dependence between individual operators, and assignment of a node where each operator is executed, by referring to data fragmentation/arrangement information indicating in which information management device 200 each data is fragmented and arranged. The operator mentioned here indicates an instruction of a search process executed in each process for acquiring a search result.

The determination unit 103 receives the generated search plan, determines an execution order of the operators contained in the search plan, and sequentially transfers operator execution information, which contains information required for execution of an operator, to the request transmission unit 104 according to the determined order.

That is, the determination unit 103 receives the information indicating the end of execution of an operator from the information management device 200 that has executed an operator, then generates operator execution information for an operator to be executed next, and transfers the generated operator execution information to the request transmission unit 104. When there is no more operator to be executed next, then the search process ends.

The request transmission unit 104 receives the operator execution information from the determination unit 103 and transmits the operator execution information to the information management device 200 that executes the operator, according to the received operator execution information.

The result reception unit 105 receives the information indicating the end of execution of the operator and an intermediate result which is an execution result of the operator, from the information management device 200 having executed the operator. Moreover, when receiving the information indicating each end of execution of operators, the result reception unit 105 informs the determination unit 103 of the end of execution of a specified operator.

The result generation unit 106 generates a search result for the search request from the intermediate result which is received from the result reception unit 105 and is finally left. For example, when returning of the search result in an XML format is specified in the search request, the plan generation unit 102 generates a search plan including an operator to generate a search result in the XML format, and thus, the result generation unit 106 generates the search result in which the intermediate result is expressed in the XML format, according to the operator.

The result transmission unit 107 transmits the generated search result to the client 400.

The information management device 200 distributes and manages databases that store therein horizontally fragmented data, searches for data according to a request from the search device 100, and sends back a search result to the search device 100. The information management device 200 includes a processor 210, a result storage unit 221, a correlation storage unit 222, and an information storage unit 231 (231a to 231d).

The information storage unit 231 stores therein each of a plurality of physically different databases each of which stores therein horizontally fragmented data as an object to be searched. A logical database “people” that stores therein information for users is horizontally fragmented into those stored in the information storage units 231a and 231b provided in the respective information management devices 200a and 200b out of the four information management devices 200a to 200d. Furthermore, a logical database “auction” that stores therein information for deals at auctions is horizontally fragmented into those stored in the information storage units 231c and 231d provided in the respective information management devices 200c and 200d.

Note that all the logical databases are not necessarily horizontally fragmented, and therefore, at least one horizontally fragmented database may be provided. Besides, the number of databases is not limited to four.

Hereinafter, the databases fragmented/arranged in the information management devices 200a, 200b, 200c, and 200d are called DB 1, DB 2, DB 3, and DB 4, respectively. More specifically, the DB 1 and DB 2 form the logical database “people”, while the DB 3 and DB 4 form the logical database “auction”.

A method of fragmenting and arranging data according to the embodiment is implemented by registering data records to be stored in databases using a round robin method without providing a particular reference using non-hash value. Specifically, the round robin method is such that the data records are sequentially and alternately registered in the databases. With this feature, even if data is registered in any order or even if there comes up unexpected new data to be registered after the operation is started, an equivalent number of data can be registered in the respective databases, which allows load distribution.

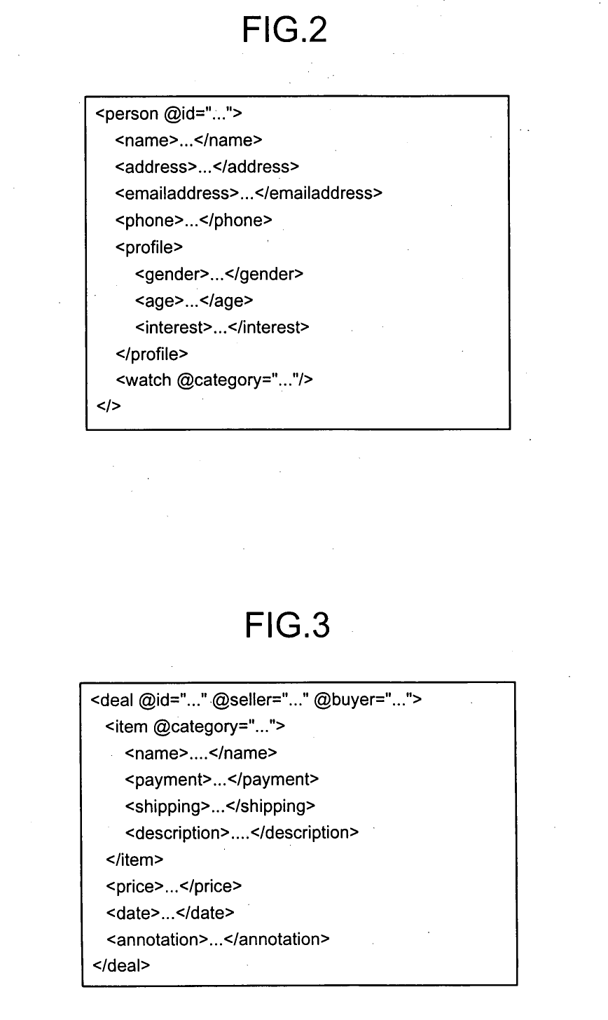

The database “people” and the database “auction” store therein data in an XML format. As shown in FIG. 2, the database “people” stores therein “person” data including various pieces of information for a user, such as ID (@id) for identifying the user, a user name (name), and a user's address (address).

As shown in FIG. 3, the database “auction” stores therein “deal” data including various pieces of information for deal at an auction, such as ID (@id) for identifying the deal at the auction, a category (item) of an item name for deal, and its price (price).

The result storage unit 221 stores therein intermediate results divided for each information storage unit 231 that is the acquisition source of an intermediate result. The correlation storage unit 222 stores therein a correlation between result identification information to identify an intermediate result and acquisition source information to identify a database as the acquisition source for each information contained in the intermediate result.

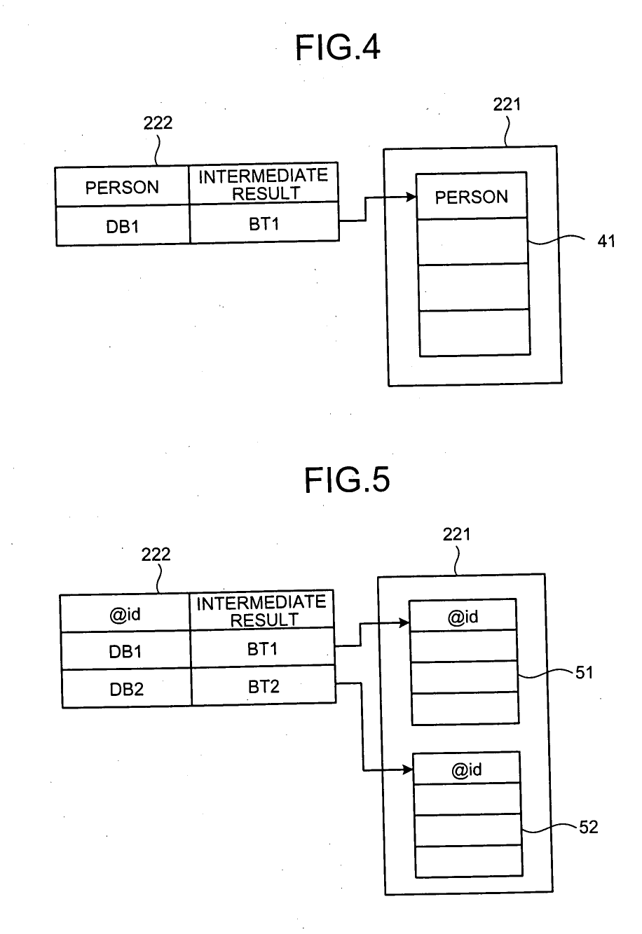

FIG. 4 represents one example of the intermediate result and the acquisition source information when the “person” data is acquired from the DB 1.

As shown in FIG. 4, the result storage unit 221 stores therein a bind table 41 which represents acquired intermediate results in a table form. The correlation storage unit 222 stores therein a correlation between result identification information (BT 1) for identifying the bind table 41 and acquisition source information (DB 1) for identifying the database as the acquisition source of the acquired intermediate result.

FIG. 5 represents another example of the intermediate result and the acquisition source when IDs (@id) for identifying users are acquired from the DB 1 and the DB 2, respectively.

As shown in FIG. 5, the result storage unit 221 stores therein two separated bind tables 51 and 52, each of which stores therein acquired intermediate results for each database as the acquisition source. The correlation storage unit 222 stores therein each correlation between result identification information (BT 1, BT 2) for identifying the bind table 51 or 52, and acquisition source information (DB 1, DB 2) for identifying each database as the acquisition source of the acquired intermediate result.

The intermediate results are separately managed for each database as the acquisition source in the above manner, which enables only a necessary intermediate result to be separately transferred to the information management device 200 that executes an operator to use the intermediate result.

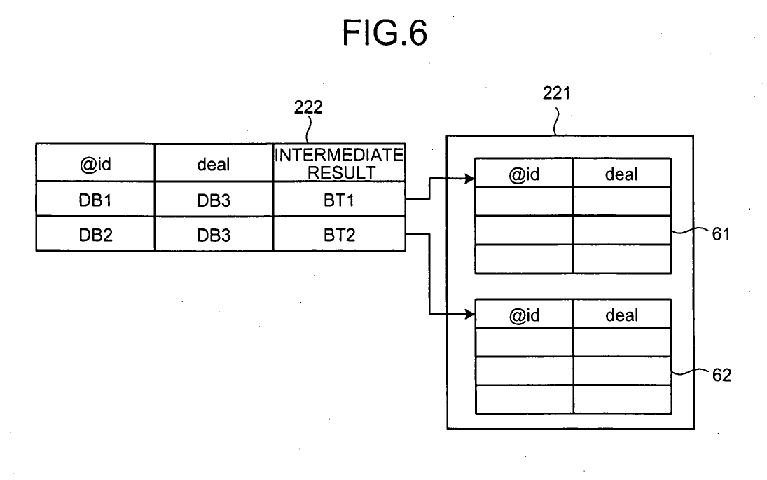

FIG. 6 represents one example of an intermediate result and acquisition source information when the “deal” data indicating deal at an auction is further acquired from the DB 3, by using the intermediate result shown in FIG. 5.

As shown in FIG. 6, the result storage unit 221 stores therein bind tables 61 and 62 in which pieces of newly acquired “deal” data are added to the bind tables 51 and 52 of FIG. 5 respectively as the intermediate results.

The correlation storage unit 222 stores therein each correlation obtained by further correlating each piece of acquisition source information (DB 3) for identifying a database as the acquisition source of the newly acquired intermediate result with each piece of result identification information (BT 1, BT 2) for identifying the bind table 61 or 62. As explained above, the acquisition source information can be different from each other for each attribute of the data acquired as the intermediate result, and therefore, a plurality of pieces of the acquisition source information can be stored for each attribute of the data.

The information storage unit 231, the result storage unit 221, and the correlation storage unit 222 can be provided with any commercially available storage medium such as a hard disk drive (HDD), an optical disc, a memory card, and a random access memory (RAM).

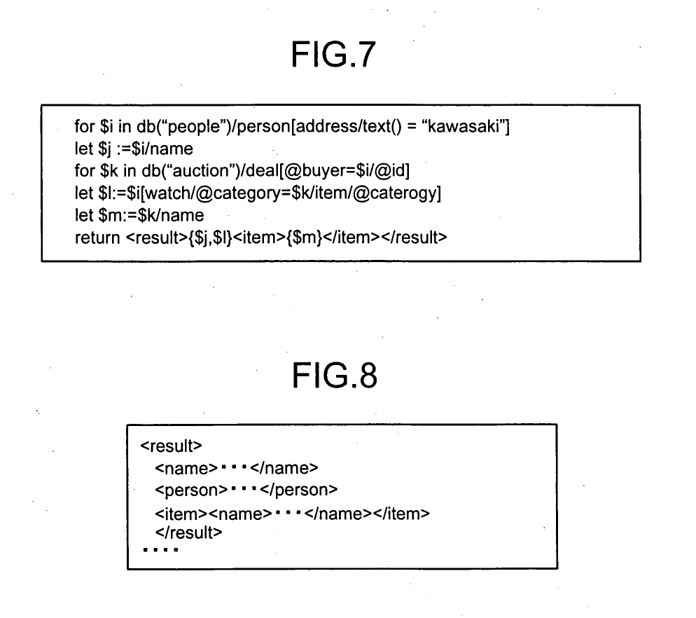

The details of the search request accepted by the acceptance unit 101 are explained below. FIG. 7 represents an example of a search formula (search request) used to search for data from the distributed databases in the four information storage units 231a to 231d, which store therein pieces of horizontally fragmented XML data respectively, and to return the data in the XML format as each search result.

The search request of FIG. 7 represents the process as follows for all the users (person) whose address is “Kawasaki”. More specifically, the search request represents that names (name) of the users are acquired, deal information (deal) for items purchased at auctions is acquired, and if there is a match between a category (watch/@category) of an item desired by a user and a category (item/@category) of an item knocked-down by the user at the auction, the name of the user and the name of the item are extracted, to output both of them.

FIG. 8 represents an output format of the search result corresponding to the return format of the search result specified in the search request of FIG. 7. The search result representing the name of the user and the category name of the item in the XML format can be output.

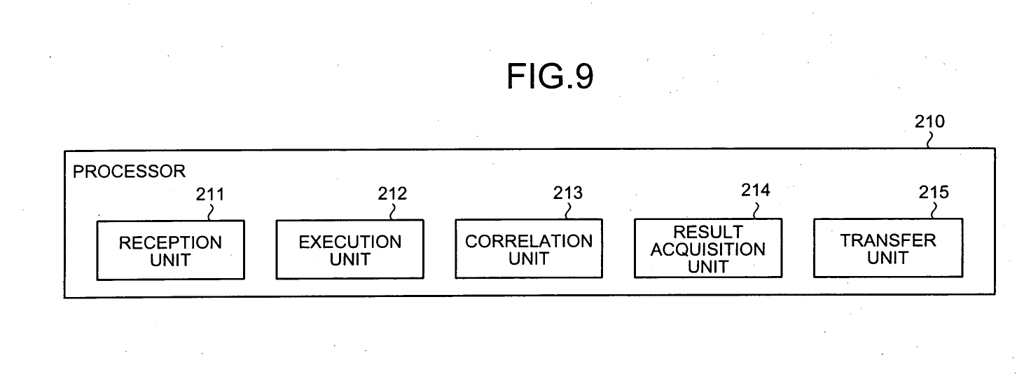

The details of the processor 210 of FIG. 1 are explained below. As shown in FIG. 9, the processor 210 includes a reception unit 211, an execution unit 212, a correlation unit 213, a result acquisition unit 214, and a transfer unit 215.

The reception unit 211 receives operator execution information from the search device 100.

The execution unit 212 executes an operator according to the received operator execution information. It is noted that if the received operator execution information relates to an operator indicating a request to transfer an intermediate result, the execution unit 212 transfers the operator execution information to the transfer unit 215. The operator execution information in this case includes information to identify the information management device 200 as the destination and information to specify an intermediate result to be transferred and also specify a column to be transferred.

The execution unit 212 stores an execution result of each operator in the result storage unit 221. More specifically, when the operator to be executed is data search, the execution unit 212 searches the database in the information storage unit 231 to obtain a result, and stores the result as the intermediate result in the result storage unit 221.

If the operator indicates acquisition of data matching a condition in which a node indicated by a specific column value of an intermediate result such as node scan of the XML data is used as a base point, the execution unit 212 records the intermediate result in the format so as to form a record the same as a corresponding column value. Furthermore, if the operator indicates computation between intermediate results such as join, the execution unit 212 records the intermediate result expressing a correlation of the column values between the intermediate results as a record.

When receiving an intermediate result transferred from another information management device 200, the execution unit 212 creates a new intermediate result based on the received intermediate result and stores the created result in the result storage unit 221. The stored intermediate result is used for the operator executed afterward. Furthermore, when the process of each operator ends, the execution unit 212 returns the information indicating the end state to the search device 100.

The correlation unit 213 stores a correlation between an intermediate result as the result of the operator executed by the execution unit 212 and acquisition source information for the database as the acquisition source of the intermediate result, in the correlation storage unit 222. Furthermore, when receiving an intermediate result transferred from another information management device 200, the correlation unit 213 creates new acquisition source information based on the acquisition source information correlated with the intermediate result, and stores the created information in the correlation storage unit 222.

When the execution unit 212 receives the operator execution information indicating a request to transfer an intermediate result, the result acquisition unit 214 acquires the intermediate result to be transferred from the result storage unit 221 by referring to the information to identify an information management device 200 as the destination described in the operator execution information and also referring to the information to specify the intermediate result and the column to be transferred.

The transfer unit 215 transfers the acquired intermediate result to the information management device 200 as the specified destination.

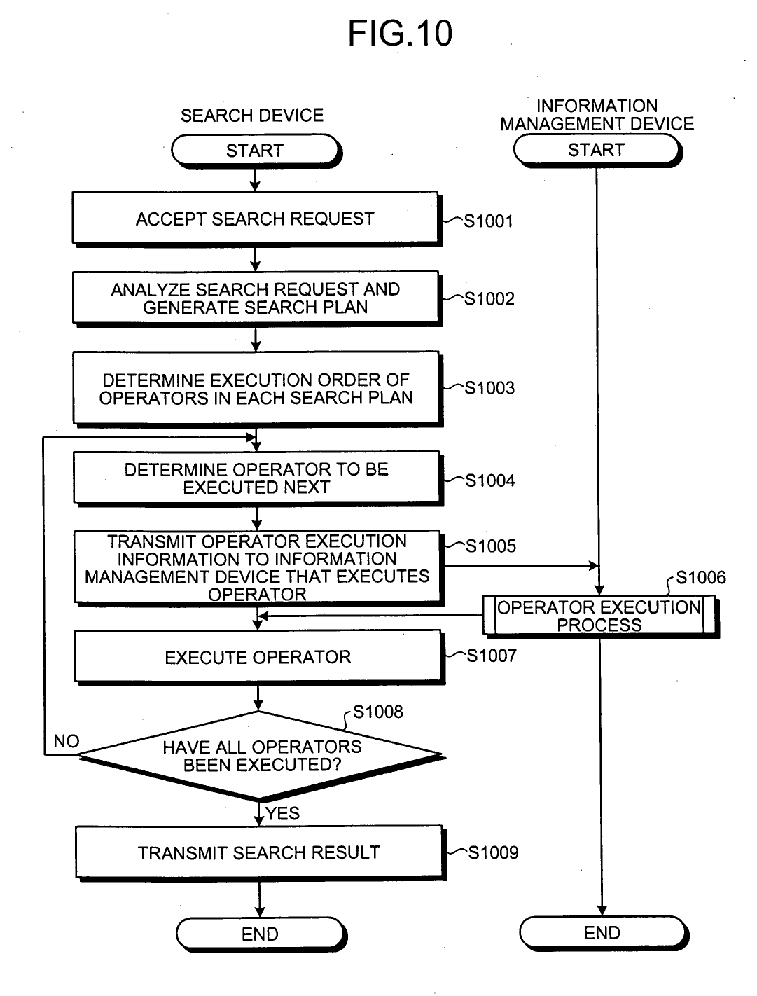

The search process performed by the search system 10 is explained below with reference to FIG. 10.

At first, the acceptance unit 101 of the search device 100 accepts a search request input from the client 400 (step S1001). Then, the plan generation unit 102 analyzes the input search request and generates a search plan (step S1002).

For example, when the search request as shown in FIG. 7 is input, the plan generation unit 102 generates a search plan so as to search for a user whose address is “Kawasaki” from the database “people”, acquire a deal having ID of a buyer that matches ID of the user from the database “auction”, and search for a user having data on an item whose category matches a category of an item to be dealt, from the database “people”.

The determination unit 103 determines an execution order of operators included in each search plan (step S1003). The determination unit 103 further determines an operator to be executed next according to the execution order (step S1004).

The request transmission unit 104 transmits the operator execution information for the operator to the information management device 200 that executes the determined operator (step S1005).

The information management device 200 receives the operator execution information, and performs an operator execution process for executing the operator according to the operator execution information (step S1006). The details of the operator execution process are explained later.

The result generation unit 106 of the search device 100 executes the operator according to the search plan (step S1007). If execution of an operator to be executed by the result generation unit 106 is not yet determined, the step is skipped. More specifically, for example, when execution of an operator to generate a search result from a finally obtained intermediate result is determined, the result generation unit 106 executes the operator.

The determination unit 103 determines whether all operators have been executed (step S1008). If not all the operators have been executed (NO at step S1008), the determination unit 103 determines an operator to be executed next and repeats the process (step S1004).

If all the operators have been executed (YES at step S1008), the result transmission unit 107 transmits the search result to the client 400 (step S1009), and ends the search process.

The details of the operator execution process at step S1006 are explained below. It is noted that the operator execution process includes a different content depending on generated search plans. For example, there can be a case where a single information management device 200 executes an operator or a case where an intermediate result is transferred between a plurality of information management devices 200 and an operator is executed.

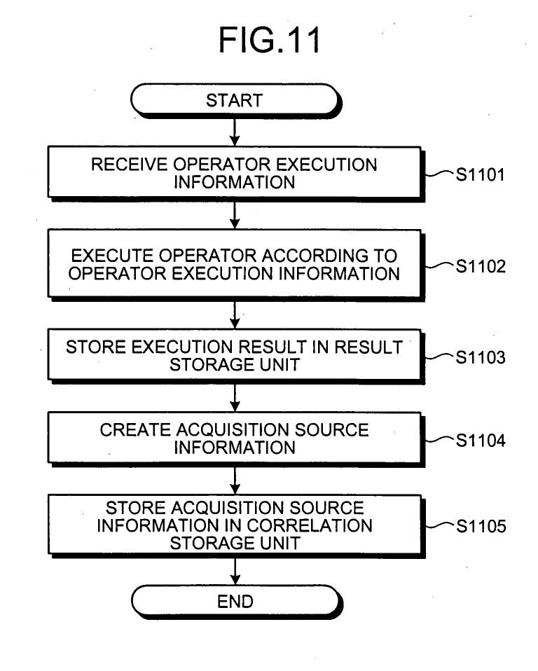

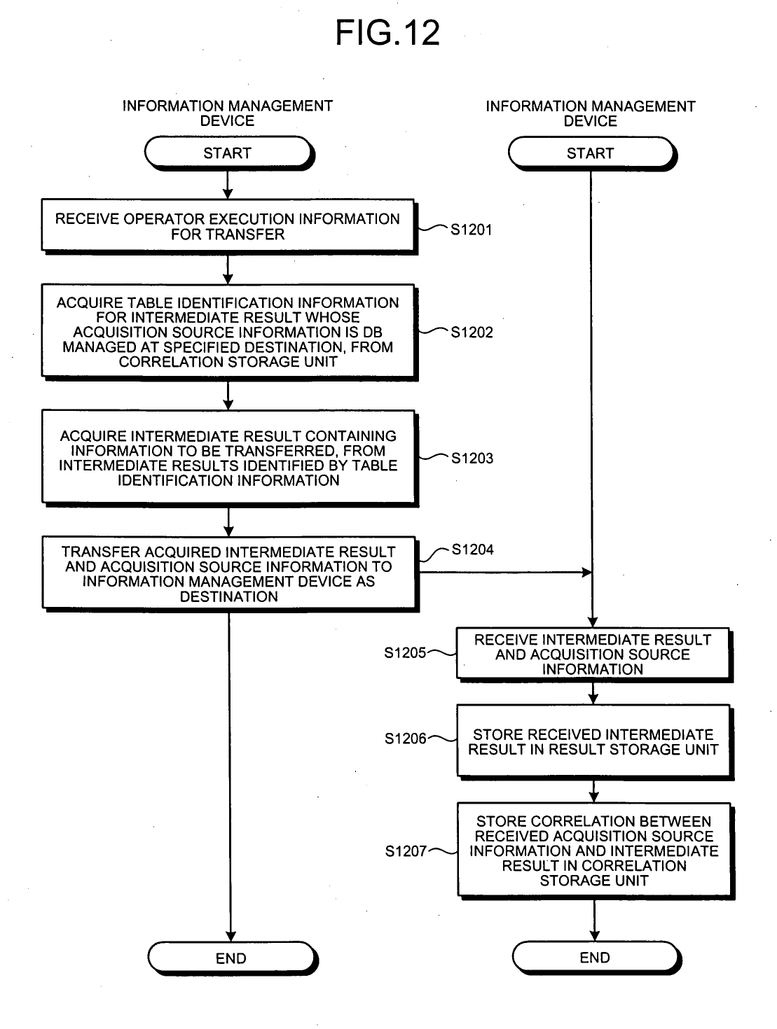

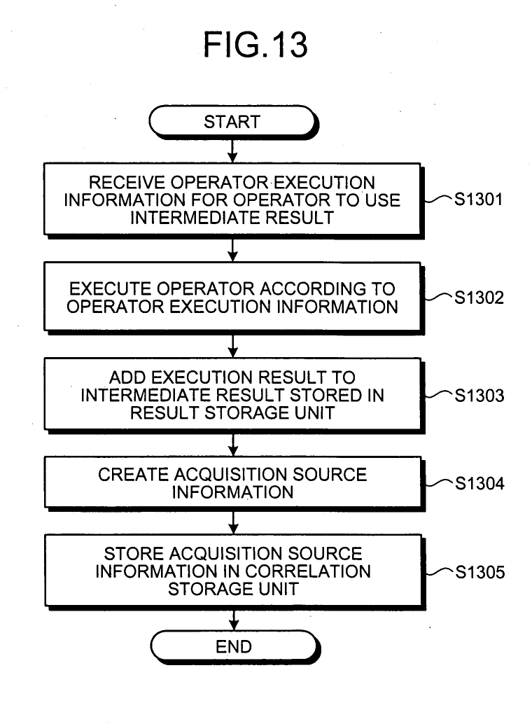

Individual explanation is given below for cases such as an operator not to use an intermediate result of another information management device 200 (FIG. 11), an operator to transfer an intermediate result (FIG. 12), and an operator to use an intermediate result of another information management device 200 (FIG. 13). The operator execution process is not limited to the three. For example, there can be an operator executed in the search device 100.

FIG. 11 is a flowchart of an operator execution process for an operator not to use an intermediate result of another information management device 200.

The reception unit 211 receives operator execution information from the search device 100 (step S1101). The execution unit 212 executes an operator according to the operator execution information (step S1102).

The execution unit 212 stores an execution result of the operator in the result storage unit 221 (step S1103). For example, when the execution unit 212 of the information management device 200a executes an operator to acquire “person” data from the database “people”, the execution unit 212 stores the acquired “person” data in the result storage unit 221. In this case, the bind table 41 as shown in FIG. 4 is stored in the result storage unit 221.

The correlation unit 213 creates acquisition source information to identify a database as the acquisition source (step S1104), and stores a correlation between the created acquisition source and an intermediate result in the correlation storage unit 222 (step S1105).

In the example, the correlation unit 213 stores the information shown in FIG. 5 in the correlation storage unit 222. The information is a correlation between “DB 1”, which is the database as the acquisition source determined as acquisition source information, and the bind table 41.

FIG. 12 is a flowchart of an operator execution process for an operator to transfer the intermediate result.

The reception unit 211 receives operator execution information indicating a request for transfer of an intermediate result, from the search device 100 (step S1201). The result acquisition unit 214 executes the process for acquiring an intermediate result to be transferred. More specifically, the result acquisition unit 214 refers to information to identify an information management device 200 as the destination specified in the operator execution information, to acquire information (table identification information) from the correlation storage unit 222, the information being used to identify a bind table for intermediate results whose acquisition source information is the database managed by the information management device 200 (step S1202).

The result acquisition unit 214 refers to information to identify a column to be transferred specified in the operator execution information, of the intermediate results identified by the acquired table identification information, and acquires an intermediate result including only the information for the column to be transferred, from the result storage unit 221 (step S1203).

With this feature, it is possible to acquire only the required information and to transfer the information to an external information management device 200, which enables reduction in the load of the transfer process and achievement of high-speed search process.

The transfer unit 215 transfers the acquired intermediate result and the acquisition source information correlated with the acquired intermediate result to the information management device 200 as the destination (step S1204).

In the information management device 200 as the destination, the reception unit 211 receives the intermediate result and the acquisition source information (step S1205). The execution unit 212 creates a new intermediate result based on the received intermediate result and stores the created result in its own result storage unit 221 (step S1206).

When receiving intermediate results from a plurality of external information management devices 200, the information management device 200 separates the respective intermediate results for each database as the acquisition source and stores the separated databases in the result storage unit 221. For example, when receiving “@id” data in the respective databases “people” as the intermediate results from the information management devices 200a and 200b, the information management device 200c separates the intermediate results corresponding to the respective devices to those for the two bind tables 51 and 52 and stores the separated intermediate results therein respectively as shown in FIG. 5.

The correlation unit 213 creates new acquisition source information by referring to the received acquisition source information, and stores a correlation between the created acquisition source information and the intermediate result created at step S1206 in the correlation storage unit 222 (step S1207).

The operator to use the intermediate result of another information management device 200 is ready to be executed based on the process, and when a request for execution of a next operator to use the intermediate result is sent from the search device 100, the operator can be executed.

FIG. 13 is a flowchart of an operator execution process for an operator to use an intermediate result of another information management device 200.

The reception unit 211 receives operator execution information for an operator to use an intermediate result, from the search device 100 (step S1301). The execution unit 212 executes the operator according to the operator execution information (step S1302).

The execution unit 212 stores the execution result of the operator in the result storage unit 221 (step S1303). At this time, the intermediate result previously stored in the result storage unit 221 is added with an intermediate result acquired by using the previously stored intermediate result and is stored in the result storage unit 221.

The correlation unit 213 creates acquisition source information to identify a database as the acquisition source (step S1304), and stores a correlation between the created acquisition source information and the intermediate result in the correlation storage unit 222 (step S1305).

In the case of the operator to use the intermediate result of another information management device 200, the execution result of a newly executed operator is added to the previously received intermediate result from another information management device 200 to create an intermediate result, and the created intermediate result is stored in the result storage unit 221. In this case, because the intermediate results are separately managed for each different database as the acquisition source, it is possible to transfer only a necessary intermediate result extracted upon transfer of the intermediate result to further another information management device 200.

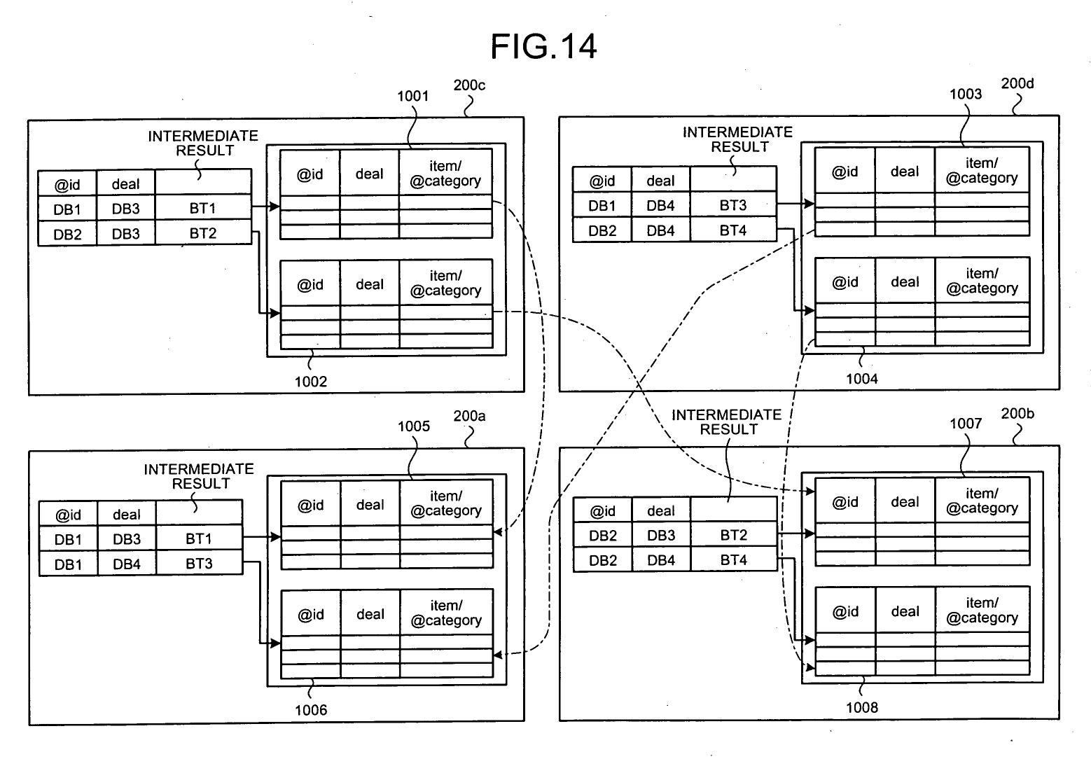

An example of an intermediate result to be transferred in the search system 10 configured in the above manner is explained below. FIG. 14 represents an example of the case where the information management devices 200a and 200b acquire “@id” data from the databases “people”, and the information management devices 200c and 200d acquire “deal” data and “item/@category” data for the respective “@id” data, and further transfer the results to the information management devices 200a and 200b respectively.

The information management device 200c is represented on the upper left side of FIG. 14, and information management device 200d is represented on its upper right side. The information management device 200a is represented on the lower left side of FIG. 14, and information management device 200b is represented on its lower right side.

For example, the information management device 200c divides the intermediate results into those for respective two acquisition sources (DB 1, DB 2), and manages the divided intermediate results as two bind tables 1001 and 1002. Therefore, when these intermediate results are to be transferred, only a necessary intermediate result can be transferred to either one of the information management devices 200a and 200b according to the acquisition source information (DB 1, DB 2).

Likewise, the information management device 200d divides the intermediate results into those for respective two acquisition sources (DB 1, DB 2), and manages the divided intermediate results as two bind tables 1003 and 1004. Consequently, a bind table 1005 corresponding to the bind table 1001 and a bind table 1006 corresponding to the bind table 1003 are transferred to the information management device 200a. Furthermore, a bind table 1007 corresponding to the bind table 1002 and a bind table 1008 corresponding to the bind table 1004 are transferred to the information management device 200b.

A specific example of the search process in the search system 10 is explained below. An example of the case where a search request with the conditions as shown in FIG. 7 is explained below based on the configuration in which the database “people” is fragmented and arranged in the DB 1 and the DB 2 and the database “auction” is fragmented and arranged in the DB 3 and the DB 4 as shown in FIG. 1. It is noted that the information management device 200 (200a to 200d) that manages each database (DB 1 to DB 4) is sometimes simply called DBn (n: 1 to 4).

The search system 10 searches for “person” whose address is “Kawasaki” (address/text( )=“Kawasaki”) from the database “people”, and stores therein the obtained result as an intermediate result. The process in this case is as follows.

Because the database “people” is fragmented into DB 1 and DB 2 and stored, the determination unit 103 generates operator execution information to search for “person” data in which the address is “Kawasaki” (address/text ( )=“Kawasaki”) from the database “people” on the respective databases of the DB 1 and the DB 2 (step S1004).

The request transmission unit 104 receives the generated operator execution information and transmits the operator execution information to the respective databases of the DB 1 and the DB 2 (step S1005). The execution units 212 on the respective databases of the DB 1 and the DB 2 that receive the operator execution information execute the corresponding operators and create intermediate results respectively.

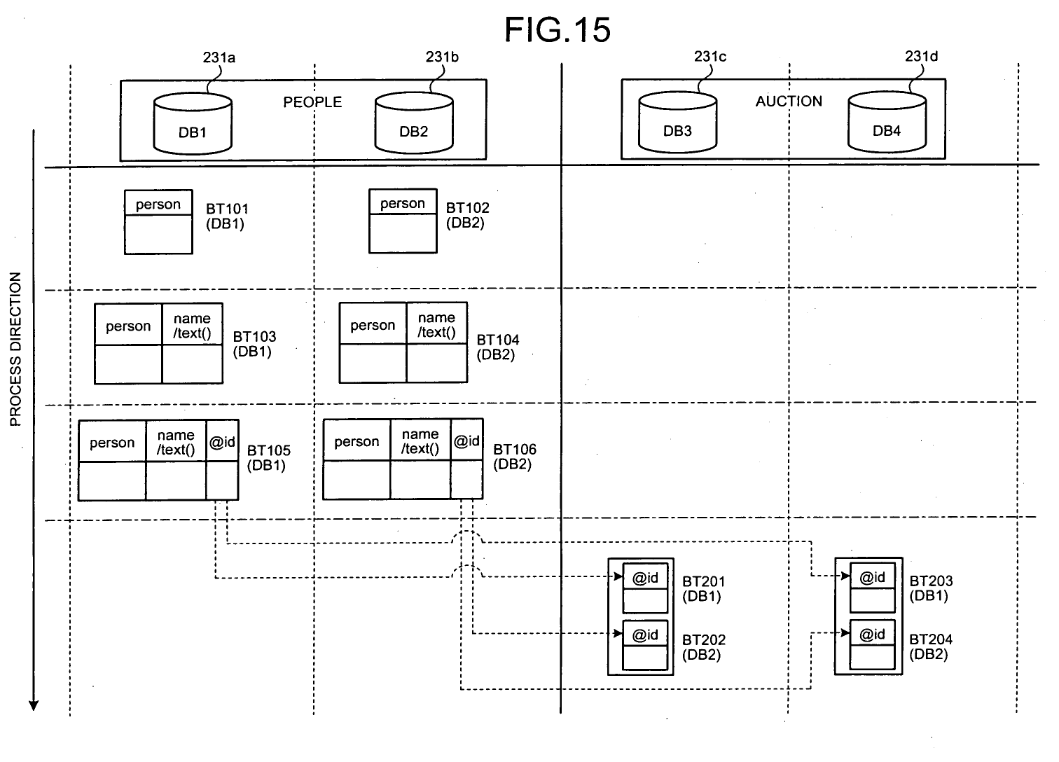

FIG. 15 to FIG. 18 are diagrams of one examples of the intermediate results generated in the search process of this example. The vertical direction of the figures represents a bind table of an intermediate result generated according to the flow of the process and acquisition source information. The horizontal direction of the figures represents the two logical databases “people” and “auction”, and also represents DB 1 to DB 4 which are databases obtained through horizontal fragmentation of the logical databases. The intermediate result given in the lower part of each database means that the database indicates the acquisition source of the intermediate result.

In the initial process, the “person” data obtained as the intermediate results on the respective databases of the DB 1 and DB 2 are stored in bind tables identified by BT 101 and BT 102, respectively. The DB 1 and the DB 2 as the acquisition source information are respectively correlated with the BT 101 and the BT 102, and the respective correlations are stored in the correlation storage unit 222.

A name (name/text( )) for the obtained “person” data is acquired from the database, and the acquired result is stored as an intermediate result. The process in this case is as follows.

The determination unit 103 generates operator execution information to execute a process of acquiring “name/text( )” for the “person” data acquired in the respective DB 1 and DB 2, the process being executed on the respective databases of the DB 1 and the DB 2 (step S1004). The request transmission unit 104 receives the generated operator execution information and transmits the received information to the respective databases of the DB 1 and DB 2 (step S1005).

The execution units 212 on the respective databases of the DB 1 and DB 2 that receive the operator execution information execute the corresponding operators and create intermediate results. In this process, the “name/text ( )” acquired as the intermediate results on the respective databases of the DB 1 and DB 2 is added to the bind tables BT 101 and BT 102, and bind tables BT 103 and BT 104 are thereby created respectively.

The “id (@id)” data for the obtained “person” data is acquired from the database, and an acquired result is stored as an intermediate result. The process in this case is as follows.

The determination unit 103 generates operator execution information to execute a process of acquiring “@id” data for the “person” data acquired in the respective DB 1 and DB 2, the process being executed on the respective databases of the DB 1 and the DB 2 (step S1004). The request transmission unit 104 receives the generated operator execution information and transmits the received information to the respective databases of the DB 1 and the DB 2 (step S1005).

The execution units 212 on the respective databases of the DB 1 and DB 2 that receive the operator execution information execute the corresponding operators and create intermediate results respectively. In this process, the “@id” acquired as the intermediate results on the respective databases of the DB 1 and DB 2 is added to the bind tables BT 103 and BT 104, and bind tables BT 105 and BT 106 are thereby created respectively.

The process explained so far is a closed process in the database “people”, and all the columns of the intermediate result is closed in either one of the DB 1 and the DB 2.

The “@id” data obtained on the DB 1 and the DB 2 up to now is used as key, to search for deal information (deal) having an attribute (@buyer) that matches the value of the “@id” data. The process in this case is as follows.

The database “auction” is stored in the DB 3 and the DB 4, and therefore, the determination unit 103 generates operator execution information to transfer the key information (@id) held in the intermediate results of the DB 1 and the DB 2 to the DB 3 and the DB 4 respectively (step S1004). The request transmission unit 104 receives the generated operator execution information and transmits the operator execution information to the respective databases of the DB 1 and DB 2 for executing a transfer process (step S1005).

The execution units 212 on the respective databases of the DB 1 and the DB 2 that receive the operator execution information execute corresponding transfer processes, and transfer intermediate results and acquisition source information to the DB 3 and the DB 4 respectively (step S1204). The DB 1 and the DB 2 transfer only the “@id” column used for the subsequent process, of the intermediate results of the DB 1 and the DB 2, to the DB 3 and the DB 4 respectively.

The execution units 212 on the respective databases of the DB 3 and DB 4 as destinations receive the transferred intermediate results, and assemble the intermediate results, respectively (step S1206). At this time, the execution units 212 also receive acquisition source information for the respectively obtained intermediate results, and record each correlation between the received acquisition source information and the intermediate result (step S1207).

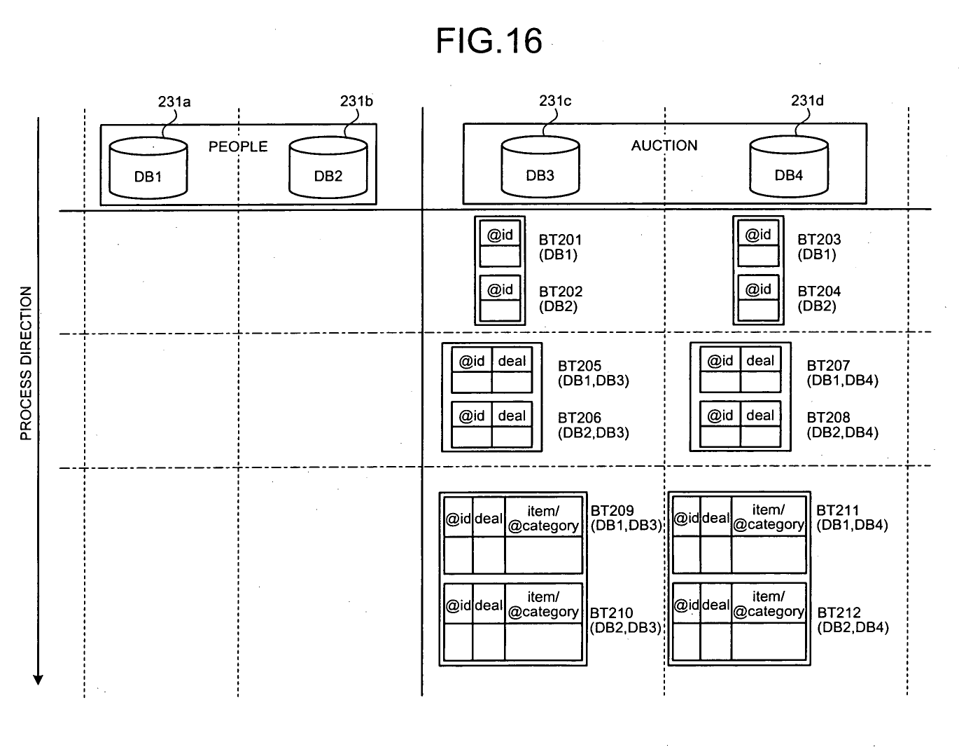

More specifically, the “@id” data as the intermediate results received from the respective databases of the DB 1 and the DB 2 are separately managed for each acquisition source. For example, as shown in FIG. 16, bind tables BT 201 and BT 202 are created on the DB 3, while bind tables BT 203 and BT 204 are created on the DB 4.

In this manner, when receiving the transferred intermediate results, each of the DB 3 and the DB 4 separately manages the intermediate results in such a manner that one obtained from the DB 1 is separated from the other one obtained from the DB 2. It is thereby possible to learn from which database each value of the columns of the intermediate results is obtained.

The “deal” data having an attribute “@buyer” that matches a value of “@id” data are searched from the respective DB 3 and the DB 4. The process in this case is as follows.

The determination unit 103 uses the “@id” of the intermediate results stored in the respective DB 3 and the DB 4 as key, to generate operator execution information to search for “deal” data that contains “@buyer” matching “@id” for the respective databases of the DB 3 and the DB 4 (step S1004). The request transmission unit 104 receives the generated operator execution information, and transmits the received operator execution information to the respective databases of the DB 3 and the DB 4 (step S1005).

The execution units 212 on the respective databases of the DB 3 and DB 4 that receive the operator execution information execute the corresponding operators and create intermediate results, respectively. The execution unit 212 and the correlation unit 213 create acquisition source information for the “deal” data obtained at this time, and add the created acquisition source information to the existing intermediate result and acquisition source information (step S1303 to step S1305).

With this feature, referring to the DB 3, an intermediate result (BT 205) and an intermediate result (BT 206) are separately managed. More specifically, the intermediate result (BT 205) has the “@id” obtained from the DB 1 and the “deal” data obtained from the DB 3, and the intermediate result (BT 206) has the “@id” obtained from the DB 2 and the “deal” data obtained from the DB 3. Referring also to DB 4, respective intermediate results in BT 207 and BT 208 are separately managed.

Values of “item/@category” used for the subsequent process are acquired from the databases of the DB 3 and the DB 4, respectively. The process in this case is as follows.

The determination unit 103 generates operator execution information to acquire “item/@category” for the respective databases of the DB 3 and the DB 4 using the intermediate results “deal” stored in the respective databases of the DB 3 and the DB 4 as each base point (step S1004). The request transmission unit 104 receives the generated operator execution information, and transmits the operator execution information to the respective databases of the DB 3 and the DB 4 where corresponding operators are executed (step S1005).

The execution units 212 on the respective databases of the DB 3 and DB 4 that receive the operator execution information execute the corresponding operators and create intermediate results respectively. The execution unit 212 and the correlation unit 213 create acquisition source information for the “item/@category” obtained at this time, and add the created acquisition source information to the existing intermediate result and acquisition source information.

Next, “person” data that contains “watch/@category” matching “item/@category” of the intermediate results obtained in the DB 3 and the DB 4 is selected. The process in this case is as follows.

The database “people” is stored in the DB 1 and the DB 2, and therefore, the determination unit 103 generates operator execution information to transfer the key information (item/@category) held in the intermediate results of the DB 3 and the DB 4 to the DB 1 and the DB 2 respectively (step S1004). The request transmission unit 104 receives the generated operator execution information and transmits the operator execution information to the respective databases of the DB 3 and DB 4 (step S1005).

The execution units 212 on the respective databases of the DB 3 and the DB 4 that receive the operator execution information execute the transfer process of corresponding intermediate results, and transfer the intermediate results to the DB 1 and the DB 2 respectively (step S1204). At this time, of the intermediate results having been obtained in the DB 3 and the DB 4, each of the DB 3 and the DB 4 acquires intermediate results of which process can continuously be performed in each of the DB 1 and the DB 2, from the result storage unit 221 by referring to the correlation storage unit 222. And each of the DB 3 and the DB 4 transfers only the acquired effective intermediate results to the corresponding database.

More specifically, based on the acquisition source information, it is determined that the “person” data referred to in the subsequent process, of the intermediate results obtained in the respective DB 3 and DB 4, is the intermediate result obtained from either the DB 1 or the DB 2. A portion obtained from the DB 1 becomes an effective intermediate result for the DB 1, and a portion obtained from the DB 2 becomes an effective intermediate result for the DB 2. The intermediate results separately managed using the acquisition source information in the above manner are transferred by each portion, which enables elimination of wasteful transfer.

The execution units 212 on the respective databases of the DB 1 and DB 2 as destinations receive the transferred intermediate results, and create the same intermediate results based on the transferred intermediate results, respectively (step S1206). At this time, each of the execution units 212 also receives acquisition source information for the obtained intermediate result, and records a correlation between the received acquisition source information and the intermediate result (step S1207).

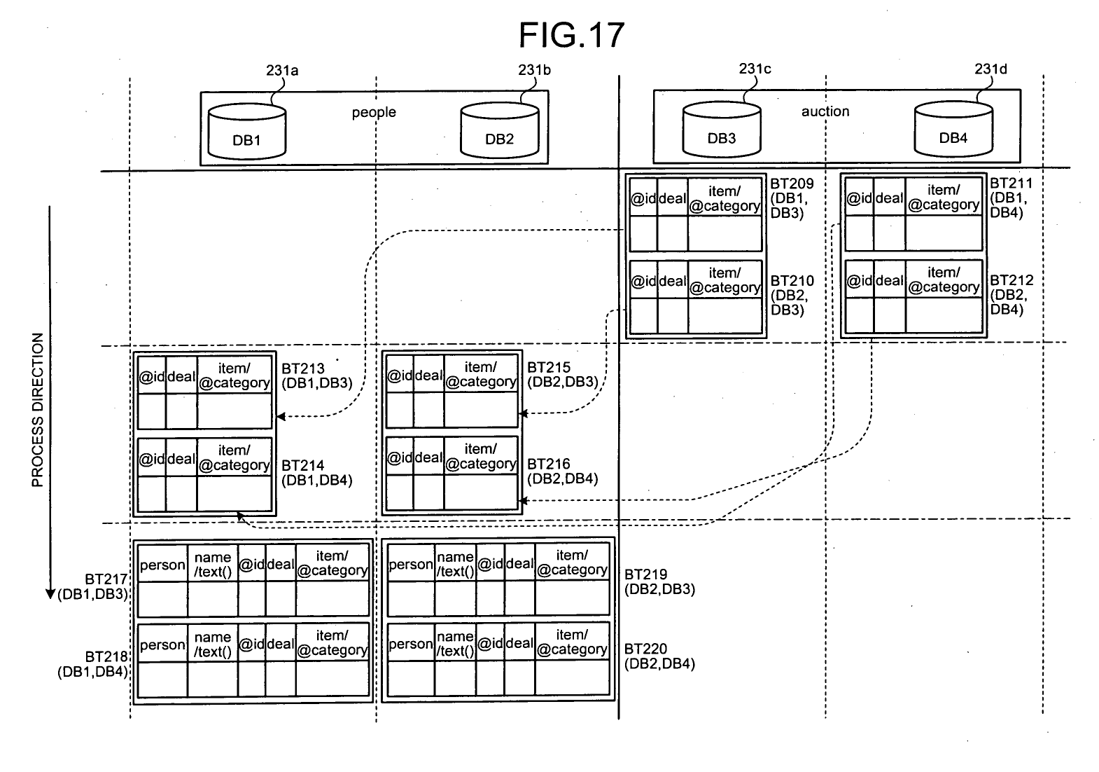

More specifically, the intermediate results received from the respective databases of the DB 3 and the DB 4 are separately managed for each acquisition source. For example, as shown in FIG. 17, BT 213 corresponding to the BT 209 on the DB 3 and BT 214 corresponding to the BT 211 on the DB 4 are created on the DB 1. Likewise, BT 215 corresponding to the BT 210 on the DB 3 and BT 216 corresponding to the BT 212 on the DB 4 are created on the DB 2.

In this manner, the DB 1 receives the transferred intermediate results, and separately manages ones obtained from the DB 3 and the DB 4 and the other ones previously obtained in the DB 1. Likewise, the DB 2 receives the transferred intermediate results, and separately manages ones obtained from the DB 3 and the DB 4 and the other ones obtained from the DB 2. It is thereby possible to learn from which database each value of the columns of the intermediate results is obtained.

The determination unit 103 generates operator execution information to join the intermediate result managed by itself to the transferred result, in each of the databases of the DB 1 and the DB 2, to integrate discretely computed results into one (step S1004). The request transmission unit 104 receives the operator execution information, and transfers the operator execution information to the respective databases of the DB 1 and the DB 2 that execute corresponding operators (step S1005).

The execution units 212 on the respective databases of the DB 1 and the DB 2 receiving the transferred operator execution information execute the corresponding operators and store intermediate results, respectively. As a result, on the DB 1, the BT 105 of FIG. 15 and the BT 213 of FIG. 17 are integrated to create BT 217, and the BT 105 of FIG. 15 and the BT 214 of FIG. 17 are integrated to create BT 218. Likewise, on the DB 2, the BT 106 of FIG. 15 and the BT 215 of FIG. 17 are integrated to create BT 219, and the BT 106 of FIG. 15 and the BT 216 of FIG. 17 are integrated to create BT 220.

At this time, acquisition source information for each column of the intermediate result obtained as the result of integration is also extracted, for each column, from the acquisition source information for the respective intermediate results, and the extracted acquisition source information is integrated with the corresponding intermediate result.

Data having the value of the attribute (watch/@category) that matches the value of “item/@category” in the intermediate result for the “person” data of the intermediate result is extracted from the respective databases of the DB 1 and the DB 2, and the obtained results are reflected to the intermediate results respectively. The process in this case is as follows.

The intermediate results required for execution of the operators are provided on the respective databases of the DB 1 and the DB 2 that perform the process. Therefore, the determination unit 103 generates operator execution information to extract “person” data having the value of attribute (watch/@category) that matches the value of “item/@category” of the intermediate result for the respective databases of the DB 1 and the DB 2 (step S1004). The request transmission unit 104 receives the operator execution information, and transfers the operator execution information to the respective databases of the DB 1 and the DB 2 that execute the operators (step S1005).

The execution units 212 on the respective databases of the DB 1 and the DB 2 receiving the transferred operator execution information execute the corresponding operators and store therein intermediate results, respectively. In this process, the “person” data extracted as the intermediate results on the respective databases of the DB 1 and the DB 2 are stored in bind tables BT 221 and BT 222 and in bind tables BT 223 and BT 224, respectively.

Because the “person” data obtained in the process are acquired from the respective databases of the DB 1 and the DB 2, the acquisition source information does not change.

The process for acquiring “deal/name/text ( )” is performed on the database “auction”. The process in this case is as follows.

The DB 3 and the DB 4 that perform the process have no intermediate result indicating “deal” data that is a base required for acquiring the “deal” data. Therefore, the determination unit 103 generates operator execution information to transfer an intermediate result indicating only the “deal” data, of the intermediate results obtained in the DB 1 and the DB 2, to the DB 3 and the DB 4 (step S1004). The request transmission unit 104 transfers the operator execution information to the respective databases of the DB 1 and the DB 2 that execute corresponding operators (step S1005).

The execution units 212 on the respective databases of the DB 1 and the DB 2 receiving the operator execution information cause the transfer units 215 to execute the corresponding transfer processes, respectively. At this time, by using the acquisition source information, the DB 1 determines an intermediate result, from the intermediate results obtained in the DB 1, which is requested from the DB 3 and indicates the “deal” data to be used for the subsequent process, and transfers the intermediate result to the DB 3. Likewise, by using the acquisition source information, the DB 1 determines an intermediate result, from the intermediate results obtained in the DB 1, which is requested from the DB 4 and indicates the “deal” data to be used for the subsequent process, and transfers the intermediate result to the DB 4. The same goes for the DB 2.

In this manner, the intermediate results separately managed using the acquisition source information are transferred by each separated unit, which enables elimination of wasteful transfer.

The execution units 212 on the respective databases of the DB 3 and the DB 4 receive the intermediate results and restore the received intermediate results, respectively (step S1206). At this time, the execution units 212 also receive the acquisition source information for the respectively obtained intermediate results, and record each correlation between the acquisition source information and the intermediate result (step S1207).

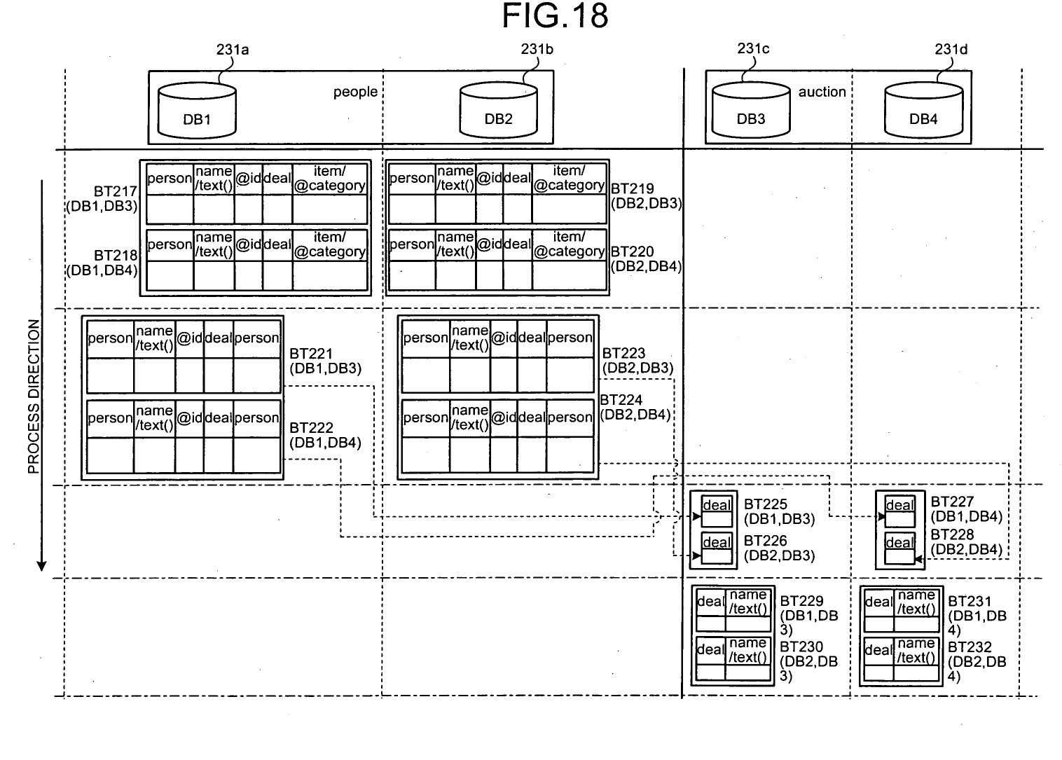

More specifically, the intermediate results received from the respective databases of the DB 1 and the DB 2 are separately managed for each acquisition source. For example, as shown in FIG. 18, BT 225 corresponding to the BT 221 on the DB 1 and BT 226 corresponding to the BT 223 on the DB 2 are created on the DB 3. Likewise, BT 227 corresponding to the BT 222 on the DB 1 and BT 228 corresponding to the BT 224 on the DB 2 are created on the DB 4.

In this manner, the DB 3 receives the transferred intermediate results, and separately manages ones obtained from the DB 1 and DB 2 and the other ones previously obtained in the DB 3. Likewise, the DB 4 receives the transferred intermediate results, and separately manages ones obtained from the DB 1 and DB 2 and the other ones previously obtained in the DB 4. It is thereby possible to learn from which database each value of the columns of the intermediate results is obtained.

A value of “item/name/text ( )” for the “deal” data obtained in the intermediate result is acquired. The process in this case is as follows.

The determination unit 103 generates operator execution information to acquire a value of “item/name/text ( )” for the “deal” data obtained in the intermediate results on the DB 3 and the DB 4 (step S1004). The request transmission unit 104 receives the generated operator execution information and transmits the operator execution information to the respective DB 3 and DB 4 that execute corresponding operators (step S1005).

The execution units 212 on the respective databases of the DB 3 and the DB 4 receiving the operator execution information execute the corresponding operators and create intermediate results, respectively. In this process, the “item/name/text ( )” obtained as the intermediate results on the respective databases of the DB 3 and the DB 4 is added to the bind tables BT 225 to BT 228, and bind tables BT 229 to BT 232 are thereby created respectively.

The search can be performed across the fragmented and stored databases based on the process according to a search formula, which enables a final search result to be acquired as a string of information consisting of columns such as “person/name/text ( )”, “person”, and “deal/item/name” as shown in FIG. 8.

As explained above, the search system according to the embodiment enables to correlate information to specify a database as the acquisition source of an intermediate result with the intermediate result, refer to the information, and to transfer only a portion, of the intermediate results, which can be an object to be processed after being transferred. Thus, wasteful communication costs can be reduced without using a particular hash function that needs to be designed before data registration. As a result, a high-speed search process can be achieved in the distributed database system. Furthermore, it is possible to balance reduction in transfer costs with easiness of change in data fragmentation during the operation of the databases.

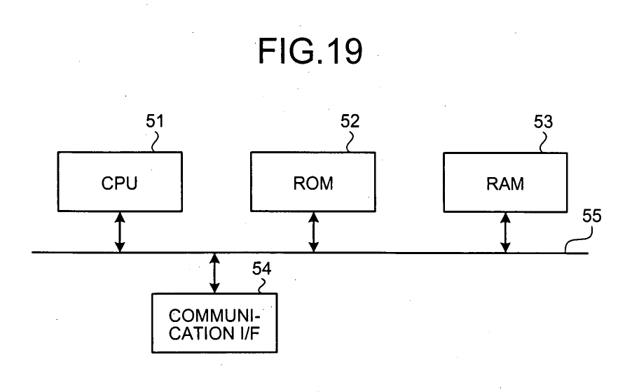

A hardware configuration of the information management device according to the embodiment is explained below with reference to FIG. 19.

The information management device includes a control device such as a central processing unit (CPU) 51, a storage device such as a read only memory (ROM) 52 and a random access memory (RAM) 53, a communication interface (I/F) 54 connected to a network for performing communication, an external storage device such as a hard disk drive (HDD) and a compact disk (CD) drive, a display device such as a display, an input device such as a keyboard and a mouse, and a bus 55 that communicates with each components. The information management device has such a hardware configuration as above using an ordinary computer.

An information management program executed in the information management device is provided by being recorded in a computer-readable recording medium such as a compact disk read only memory (CD-ROM), a flexible disk (FD), a compact disk recordable (CD-R), and digital versatile disk (DVD), in a file with an installable format or an executable format.

The information management program may also be provided by being stored on a computer connected to a network such as the Internet and downloaded through the network. The information management program may be provided or distributed through the network.

The information management program may also be provided by being previously incorporated in ROM or the like.

The information management program is configured with modules including the components (reception unit, execution unit, correlation unit, result acquisition unit, and transfer unit). As an actual hardware, the CPU 51 (processor) reads the information management program from the recording medium and executes the program, so that the components are loaded on a main storage device and generated thereon.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A search system comprising:
a plurality of information management devices that manage a plurality of databases for each database, information being distributed and stored in the databases; and
a search device that is connected to the information management devices through a network and searches for the information from the information management devices, wherein
the search device includes
an acceptance unit that accepts a search request for the information sent from a client terminal connected to the network;
a plan generation unit that analyzes the accepted search request and generates a search plan containing a search instruction to be executed by the information management devices;
a determination unit that receives the search plan generated by the plan generation unit, determines the information management devices each of which executes the search instruction contained in the search plan, and generates execution information used to execute the search instruction; a request transmission unit that transmits the execution information generated by the determination unit to any one of the determined information management devices, for each search instruction contained in the generated search plan;
a result reception unit that receives an execution result of the search instruction from the information management device;
a result generation unit that generates a search result based on the received execution result; and
a result transmission unit that transmits the generated search result to the client terminal, and
the information management device includes
a reception unit that receives the execution information from the search device;
an execution unit that executes the search instruction by using the received execution information;
a correlation unit that correlates an execution result of the executed search instruction with acquisition source information previously specified to identify each of the databases as an acquisition source of the execution result; and
a transfer unit that transfers the execution result correlated with the acquisition source information to another information management device that executes the search instruction to use the execution result, wherein
the execution unit further executes the search instruction to use the execution result received from the another information management device, and adds the execution result of executed search instruction to the received execution result,
the correlation unit further correlates the acquisition source information to identify the database as an acquisition source of the execution result of the executed search instruction, with the received execution result added with the execution result of the executed search instruction, and
the transfer unit further transfers the execution result correlated with the acquisition source information to the information management device that manages the database identified by the acquisition source information correlated to the execution result.

2. The system according to claim 1, wherein
the information management device further includes a result storage unit capable of storing the execution results for each database as the acquisition source of the execution results, and
the execution unit stores the received execution results in the result storage unit for each database as the acquisition source, based on the acquisition source information correlated with the received execution result, and adds the execution result of the executed search instruction to each of the stored execution results.

3. The system according to claim 2, wherein
the information management device further includes
a correlation storage unit capable of correlating and storing result identification information to identify the execution result for each database as an acquisition source, with the acquisition source information to identify the database as the acquisition source of the execution result, and
the correlation unit correlates the result identification information to identify the execution result of the executed search instruction, with the acquisition source information to identify the database as an acquisition source of the execution result of the executed search instruction, and stores the correlated result identification information and the acquisition source information in the correlation storage unit.

4. The system according to claim 1, wherein
the plan generation unit generates the search plan containing information for the search instruction for transferring the execution result,
the determination unit generates the execution information for the search instruction for transferring the execution result, to the information management device that executes the search instruction to use the execution result, and
the transfer unit transfers the execution result to the information management device that executes the search instruction to use the execution result, when the transfer unit receives the execution information for the search instruction for transferring the execution result.

5. The system according to claim 4, wherein
the determination unit generates the execution information containing specific information to specify the execution result to be used from among the execution results, and
the information management device further includes
a result acquisition unit that acquires the execution result specified by the specific information contained in received execution information from among the execution results of the executed search instruction, wherein
the transfer unit transfers the acquired execution result to the information management device that executes the search instruction to use the execution result.

6. The system according to claim 5, wherein
the determination unit generates the execution information containing device identification information to identify the information management device as a destination, and
the transfer unit transfers the acquired execution result to the information management device identified by the device identification information.

7. The system according to claim 1, wherein
the result generation unit executes the search instruction contained in the generated search plan to generate the search result from the received execution result.

8. The system according to claim 1, wherein
the determination unit further determines an execution order of the search instruction based on the generated search plan, and
the request transmission unit transmits the execution information to the determined information management device in the determined execution order.

9. A search method in a search system, the search system including a plurality of information management devices and a search device, wherein the information management devices manage a plurality of databases for each database, information is distributed and stored in the databases, and the search device is connected to the information management devices through a network and searches for the information from the information management devices, wherein the search method comprises:
accepting by the search device a search request for the information sent from a client terminal connected to the network;
analyzing by the search device the accepted search request and generating a search plan containing a search instruction to be executed by the information management devices;
determining by the search device the information management devices each of which executes the search instruction contained in the generated search plan and generating execution information used to execute the search instruction;
transmitting by the search device the generated execution information to any one of the determined information management devices, for each search instruction contained in the generated search plan;
receiving by the information management device the execution information from the search device;
executing by the information management device the search instruction by using the received execution information;
correlating by the information management device an execution result of the executed search instruction with acquisition source information previously specified to identify each of the databases as an acquisition source of the execution result;
transferring by the information management device the execution result correlated with the acquisition source information to another information management device that executes the search instruction to use the execution result;
executing by the information management device the search instruction to use the execution result received from the another information management device, and adding the execution result of the executed search instruction to the received execution result;
correlating by the information management device the acquisition source information to identify the database as an acquisition source of the execution result of the executed search instruction, with the received execution result added with the execution result of the executed search instruction;
transferring by the information management device the execution result correlated with the acquisition source information to the information management device that manages the database identified by the acquisition source information correlated to the execution result;
receiving by the search device the execution result from the information management device;
generating by the search device a search result based on the received execution result; and
transmitting by the search device the generated search result to the client terminal.

10. An information management device connected to an external information management device and a search device through a network, wherein the external information management device manages a plurality of databases for each database, information is distributed and stored in the databases, and the search device searches for the information, wherein the information management device comprises:
an information storage unit that stores the database;
a reception unit that receives execution information used to execute a search instruction from the search device;
an execution unit that executes the search instruction by using the received execution information;
a correlation unit that correlates an execution result of the executed search instruction with acquisition source information previously specified to identify each of the databases as an acquisition source of the execution result; and
a transfer unit that transfers the execution result correlated with the acquisition source information to the external information management device that executes the search instruction to use the execution result, wherein
the execution unit further executes the search instruction to use the execution result received from the external information management device, and adds the execution result of the executed search instruction to the received execution result,
the correlation unit further correlates the acquisition source information to identify the database as an acquisition source of the execution result of the executed search instruction, with the received execution result added with the execution result of the executed search instruction, and
the transfer unit further transfers the execution result correlated with the acquisition source information, to the external information management device that manages the database identified by the acquisition source information correlated to the execution result.
